(19) United States
(12) Patent Application Publication
(10) Pub. No.: US 2026/0112612 A1
(43) Pub. Date: Apr. 23, 2026

(54) COMPOSITE SODIUM ION BATTERY CATHODE MATERIAL WITH RADIAL HETEROJUNCTION AND PREPARATION METHOD THEREOF

(71) Applicant: Hebei University, Baoding (CN)

(72) Inventor: Jixue SHEN, Baoding (CN)

(73) Assignee: Hebei University, Baoding (CN)

(21) Appl. No.: 19/200,734

(22) Filed: May 7, 2025

(30) Foreign Application Priority Data
Oct. 22, 2024 (CN) 202411472835.7

(51) Int. Cl. H01M 4/36; C01G 53/51; H01M 4/505; H01M 4/525; H01M 10/054; H01M 10/42

(52) U.S. Cl. CPC H01M 4/366; C01G 53/51; H01M 4/505; H01M 4/525; H01M 10/4235; C01P 2002/22; C01P 2002/70; C01P 2004/03; C01P 2004/61; C01P 2004/84; C01P 2006/40; H01M 10/054

(57) ABSTRACT

A composite sodium ion battery cathode material with radial heterojunction and a preparation method thereof are provided. The cathode material is prepared by sintering a precursor and a sodium source, and the prepared cathode material is a core-shell structure with a radial heterojunction, the core of the cathode material is an O3-type nickel-manganese-based layered oxide, there is a coating material on the surface of the core, and the coating material is a P2-type nickel-manganese-based layered oxide. By adopting the above composite sodium ion battery cathode material with radial heterojunction and preparation method thereof, while reducing the cost of the materials, the composite cathode materials with radially heterogeneous distributions are synthesized by constructing different thicknesses of Ni_{0.3}Mn_{0.7}(OH)₂ on the surface of Ni_{0.5}Mn_{0.5}(OH)₂ precursor, so as to improve the air stability and cycling stability of the materials, and improve the sodium ion transmission kinetic property.

### CROSS REFERENCE TO THE RELATED APPLICATIONS

This application is based upon and claims priority to Chinese Patent Application No. 202411472835.7, filed on Oct. 22, 2024, the entire contents of which are incorporated herein by reference.

### TECHNICAL FIELD

The present invention relates to the technical field of sodium ion batteries, in particular to a composite sodium ion battery cathode material with radial heterojunction and a preparation method thereof.

### BACKGROUND

The demand for lithium resources is increasing rapidly with the progress of society and the popularization and development of new-energy vehicles, while the limited reserves and uneven distribution of lithium resources have led to rising costs, which limits the application of lithium resources in the field of large-scale power storage. Comparatively, sodium ion batteries have similar charge-discharge mechanisms with lithium ion batteries, and sodium resources are abundant and widely distributed, which makes the development of sodium ion battery technology a positive prospect for large-scale energy storage systems.

The design and improvement of cathode materials for sodium-ion batteries are crucial for improving the performance of the batteries as an energy storage technology that has attracted much attention, with the key to improving the interfacial charge transfer, cyclic structure stability, air stability, and high voltage stability of the materials.

### SUMMARY

The present invention aims to provide a composite sodium ion battery cathode material with radial heterojunction and a preparation method thereof, while reducing the cost of the materials, the composite cathode materials with radially heterogeneous distributions are synthesized by constructing different thicknesses of Ni_{0.3}Mn_{0.7}(OH)₂ on the surface of Ni_{0.5}Mn_{0.5}(OH)₂ precursor, so as to improve the air stability and cycling stability of the materials, and improve the sodium ion transmission kinetic property, the present invention is low-cost, simple and reasonable, with good electrical properties, and is suitable for commercialized production.

In order to achieve the above objective, the present invention provides a composite sodium ion battery cathode material with radial heterojunction, where the cathode material is prepared by sintering a precursor and a sodium source, the prepared cathode material is a core-shell structure with a radial heterojunction, the core of the cathode material is an O3-type nickel-manganese-based layered oxide, there is a coating material on the surface of the core, and the coating material is a P2-type nickel-manganese-based layered oxide.

Preferably, a thickness of the coating material is 0-1 μm.

Preferably, a particle size of the precursor material is 3.6-4.2 μm, the precursor has a core-shell structure, a chemical formula of the core is Ni_{0.5}Mn_{0.5}(OH)₂, Ni_{0.3}Mn_{0.7}(OH)₂ is deposited on a surface of the core, and a size of the Ni_{0.3}Mn_{0.7}(OH)₂ is x μm, wherein 0≤x≤1.

The present invention provides a preparation method for the composite sodium ion battery cathode material with radial heterojunction, the preparation method includes the following steps:
step 1, dissolving nickel salt and manganese salt in deionized water according to proportion to obtain a first mixed solution and a second mixed solution respectively, preparing a precipitant solution by adding a precipitant into deionized water to dissolve, preparing a complexing agent solution by diluting a complexing agent to a certain concentration;
step 2, simultaneously introducing the first mixed solution, the precipitant solution and the complexing agent solution into a reaction kettle protected by a protective gas, maintaining pH and temperature in the reaction kettle, taking out the material when the particle size of the material reaches a requirement, and then switching the salt solution in the reaction kettle from the first mixed solution to the second mixed solution, and repeating the above operation;
step 3, obtaining Ni_{0.5}Mn_{0.5}(OH)₂ and different sizes of Ni_{0.3}Mn_{0.7}(OH)₂ coated precursor particles by washing and drying the extracted materials;
step 4, obtaining a mixed material by uniformly mixing sodium source and precursor particles according to a certain molar ratio; and
step 5, firstly sintering the mixed material in an air atmosphere, secondly transferring the mixed material to an atmosphere furnace for continued sintering, and finally synthesizing a series of cathode material NaₓNi_{y}Mn₂O₂ samples.

Preferably, in step 1, the nickel salt is one or more of nickel sulfate, nickel nitrate and nickel chloride, the manganese salt is one or more of manganese sulfate, manganese nitrate and manganese chloride, the precipitant is one or more of sodium hydroxide, sodium carbonate, sodium bicarbonate, potassium hydroxide, potassium carbonate and potassium bicarbonate, and the complexing agent is one or more of ammonia and oxalic acid.

Preferably, a concentration of OH⁻/CO₃²⁻/HCO³⁻ in the precipitant solution is 3-7 mol/L and a concentration of the complexing agent solution is 1.5-2 mol/L.

Preferably, a ratio of Ni and Mn in the first mixed solution is 1:1, the ratio of Ni and Mn in the second mixed solution is 3:7, and both a concentration of the first mixed solution and the second mixed solution is 3-10 mol/L.

Preferably, a capacity of the reaction kettle is 50 L, the protective gas is nitrogen or argon, a pH in the reaction kettle is 11.0-11.6, and an ammonia concentration is maintained at 6-9 g/L.

Preferably, in step 4, the sodium source is one or more of Na₂CO₃, NaOH and NaNO₃, and the sodium source and the precursor particles are uniformly mixed according to a molar ratio of Na:M=0.9:1.

Preferably, in step 5, the mixed material is first sintered at 500° C. for 6 h in the air atmosphere, and then transferred to an oxygen atmosphere furnace and sintered at 900° C. for 24 h.

Therefore, the present invention adopts the above-mentioned composite sodium ion battery cathode material with radial heterojunction and the preparation method thereof, which has the following beneficial effects:
(1) sodium-ion batteries and lithium-ion batteries have similar charge-discharge mechanisms, but sodium resources are more abundant and widely distributed than lithium resources, and the cost is lower, moreover, sodium-ion batteries are safer, with relatively high internal resistance and less instantaneous heat generation in short-circuit conditions, so they have higher safety and cold and heat resistance.
(2) in the present invention, by constructing Ni_{0.3}Mn_{0.7}(OH)₂ with different thicknesses on the surface of Ni_{0.5}Mn_{0.5}(OH)₂, the composite cathode material with radial heterogeneous component distribution is synthesized, the problems of poor air stability of the O3-type nickel-manganese-based layered oxide are solved, the air stability and cycle stability of the material are improved, and the sodium ion transmission kinetic performance is improved.
(3) The cathode material prepared by the present invention has good cycle performance and rate performance.
(4) The preparation method for the cathode material provided by the present invention is simple in operation, low in cost, and has commercial application value.

Further detailed descriptions of the technical scheme of the present invention can be found in the accompanying drawings and embodiments.

### BRIEF DESCRIPTION OF THE DRAWINGS

FIG. 1 is a scanning electron microscope (SEM) view of a precursor prepared in embodiment 2 of a composite sodium ion battery cathode material with radial heterojunction and a preparation method thereof of the present invention;

FIG. 2 is an SEM view of a cathode material prepared in embodiment 2 of a composite sodium ion battery cathode material with radial heterojunction and a preparation method thereof of the present invention;

FIG. 3 is a partially enlarged SEM view of a precursor prepared in embodiment 2 of a composite sodium ion battery cathode material with radial heterojunction and a preparation method thereof of the present invention;

FIG. 4 is a partially enlarged SEM view of a cathode material prepared in embodiment 2 of a composite sodium ion battery cathode material with radial heterojunction and a preparation method thereof of the present invention;

FIG. 5 is an X-ray diffraction (XRD) pattern of a cathode material prepared in embodiment 2 of a composite sodium ion battery cathode material with radial heterojunction and a preparation method thereof of the present invention;

FIG. 6 is a diagram of a cycle performance comparison at 2.0-4.0V between embodiment 2 and comparative embodiment 1 of a composite sodium ion battery cathode material with radial heterojunction and a preparation method thereof of the present invention.

### DETAILED DESCRIPTION OF THE EMBODIMENTS

The technical solution of the present invention will be further elaborated hereafter in conjunction with accompanying drawings and embodiments.

Unless otherwise defined, technical or scientific terms used in the present invention are to be given their ordinary meaning as understood by those of ordinary skill in the art to which the present invention belongs.

### EMBODIMENT

The present invention provides the composite sodium ion battery cathode material with radial heterojunction, where the cathode material is prepared by sintering the precursor and the sodium source, the prepared cathode material is the core-shell structure with the radial heterojunction, the core of the cathode material is the O3-type nickel-manganese-based layered oxide, there is the coating material on the surface of the core, and the coating material is the P2-type nickel-manganese-based layered oxide, the thickness of the coating material is 0-1 μm.

The particle size of the precursor material is 3.6-4.2 μm, the precursor has the core-shell structure, the chemical formula of the core is Ni_{0.5}Mn_{0.5}(OH)₂, Ni_{0.3}Mn_{0.7}(OH)₂ is deposited on the surface of the core, and the size of the Ni_{0.3}Mn_{0.7}(OH)₂ is x μm, wherein 0≤x≤1.

The present invention further provides the preparation method for the composite sodium ion battery cathode material with radial heterojunction, the preparation method includes the following steps:
step 1, nickel salt and manganese salt were dissolved in deionized water according to proportion to obtain the first mixed solution and second mixed solution respectively, the precipitant solution was prepared by adding the precipitant into deionized water to dissolve, and the complexing agent solution was prepared by diluting the complexing agent to a certain concentration; nickel salts (such as nickel sulfate, nickel chloride, etc.) can increase the nickel content in the cathode material, thereby increasing the energy density of the battery. The increase in the proportion of nickel can make the battery store more electric energy and increase its endurance. The addition of manganese salts (such as manganese sulfate, manganese nitrate, etc.) can improve the structural stability and safety of cathode materials. Manganese can help to form a stable lattice structure and resist the structural changes caused by the charge-discharge cycle, thereby prolonging the battery life.

The ratio of Ni and Mn in the first mixed solution is 1:1, and the concentration of each solution is 2 M, the ratio of Ni and Mn in the second mixed solution is 3:7, and the concentration of each solution is 2 M, and both the concentration of the first mixed solution and the second mixed solution is 3-10 mol/L. By adjusting the ratio of nickel and manganese, the charge-discharge efficiency, cycle stability and rate performance of the battery can be optimized to meet the requirements of different application fields.

The nickel salt is one or more of nickel sulfate, nickel nitrate and nickel chloride, nickel sulfate is nickel sulfate hexahydrate, the manganese salt is one or more of manganese sulfate, manganese nitrate and manganese chloride, manganese sulfate is manganese sulfate monohydrate, the precipitant is one or more of sodium hydroxide, sodium carbonate, sodium bicarbonate, potassium hydroxide, potassium carbonate and potassium bicarbonate, and the complexing agent is one or more of ammonia and oxalic acid.

The concentration of OH⁺/CO₃²⁻/HCO³⁻ in the precipitant solution is 3-7 mol/L, and the concentration of the complexing agent solution is 1.5-2 mol/L. The complexing agent can form a stable complex with the metal ions, and can also improve the solubility of the metal salt, and the precipitant can promote the prefabrication reaction of the metal ions in the solution to form precipitation insoluble in water.

Step 2, the first mixed solution, the precipitant solution and the complexing agent solution were simultaneously introduced into the reaction kettle protected by the protective gas, the pH and temperature were maintained in the reaction kettle, and the material was taken out when the particle size of the material reaches the requirement, and then the salt solution in the reaction kettle was switched from the first mixed solution to the second mixed solution, and the above operation was repeated.

Step 3, the precursor particles with different sizes were obtained by washing and drying the extracted materials, the precursor particles were Ni_{0.5}Mn_{0.5}(OH)₂ and different sizes of Ni_{0.3}Mn_{0.7}(OH)₂ coated precursor particles. In the reaction process of first mixed solution, when the particle size of the material reached 3.6 μm, the material was taken out, in the reaction process of second mixed solution, when the particle size of the material reached 3.8 μm, 4.0 μm and 4.2 μm, the materials were taken out respectively.

Step 4, the mixed material was obtained by uniformly mixing sodium source and precursor particles according to a certain molar ratio; the sodium source is one or more of Na₂CO₃, NaOH and NaNO₃, and the sodium source and the precursor particles were uniformly mixed according to the molar ratio of Na:M=0.9:1.

Step 5, firstly the mixed material was sintered in the air atmosphere, secondly, it was transferred to the atmosphere furnace for continued sintering, and finally, a series of cathode material NaₓNi_{y}Mn₂O₂ samples were synthesized, where the mixed material was first sintered at 500° C. for 6 h in the air atmosphere, and then transferred to the oxygen atmosphere furnace and sintered at 900° C. for 24 h, and the final synthesized cathode materials were denoted as NM, NM+0.2 μm, NM+0.4 μm and NM+0.6 μm, respectively.

### Embodiment 1

This embodiment prepares the composite sodium ion battery cathode material with radial heterojunction, including the following steps:

(1) nickel sulfate hexahydrate and manganese sulfate monohydrate were dissolved in deionized water according to the required ratio to obtain two mixed solutions. Where the Ni:Mn in the first mixed solution was 1:1, the Ni:Mn in the second mixed solution was 3:7, and the solution concentration was 2 M.

(2) Firstly, the first mixed solution, 4 M NaOH solution and 2 M NH₃·H₂O solution were simultaneously introduced into the reactor with nitrogen as the protective gas, the pH in the reactor was maintained at 11.2, and the ammonia concentration was maintained at 7.5 g/L, when the particle size of the material in the reactor reached 3.6 μm, 200 g of the material was taken out.

Then the first mixed solution was switched to the second mixed solution, the pH in the reactor was maintained at 11.2, and the ammonia concentration was maintained at 7.5 g/L, when the particle size of the material in the reactor reached 3.8 μm, 200 g of material was taken out each time; the precursor particles were screened out after washing and drying, where the core of the precursor particles was Ni_{0.5}Mn_{0.5}(OH)₂, and Ni_{0.3}Mn_{0.7}(OH)₂ with a size of 0.2 μm was deposited on the surface of the core.

(3) Na₂CO₃ and precursor particles were mixed uniformly according to the molar ratio of 0.9:1 (Na:M) to obtain the mixed material, the mixed material was first sintered at 500° C. for 6 h in the air atmosphere, and then transferred to the oxygen atmosphere furnace and sintered at 900° C. for 24 h. The cathode material sample can be obtained and denoted as NM+0.2 μm.

(4) The specific capacity of the first cycle discharge and the capacity retention rate after 300 cycles of the composite sodium ion battery cathode material were measured.

### Embodiment 2

This embodiment prepares the composite sodium ion battery cathode material with radial heterojunction, including the following steps:

(1) nickel sulfate hexahydrate and manganese sulfate monohydrate were dissolved in deionized water according to the required ratio to obtain two mixed solutions. Where the Ni:Mn in the first mixed solution was 1:1, the Ni:Mn in the second mixed solution was 3:7, and the solution concentration was 2 M.

(2) Firstly, the first mixed solution, 4 M NaOH solution and 2M NH₃·H₂O solution were simultaneously introduced into the reactor with nitrogen as the protective gas, the pH in the reactor was maintained at 11.2, and the ammonia concentration was maintained at 7.5 g/L, when the particle size of the material in the reactor reached 3.6 μm, 200 g of the material was taken out.

Then the first mixed solution was switched to the second mixed solution, the pH in the reactor was maintained at 11.2, and the ammonia concentration was maintained at 7.5 g/L, when the particle size of the material in the reactor reached 4.0 μm, 200 g of material was taken out each time; the precursor particles were screened out after washing and drying, where the core of the precursor particles was Ni_{0.5}Mn_{0.5}(OH)₂, and Ni_{0.3}Mn_{0.7}(OH)₂ with a size of 0.4 μm was deposited on the surface of the core.

(3) Na₂CO₃ and precursor particles were mixed uniformly according to the molar ratio of 0.9:1 (Na:M) to obtain the mixed material, the mixed material was first sintered at 500° C. for 6 h in the air atmosphere, and then transferred to the oxygen atmosphere furnace and sintered at 900° C. for 24 h. The cathode material sample can be obtained and denoted as NM+0.4 μm.

(4) The specific capacity of the first cycle discharge and the capacity retention rate after 300 cycles of the composite sodium ion battery cathode material were measured.

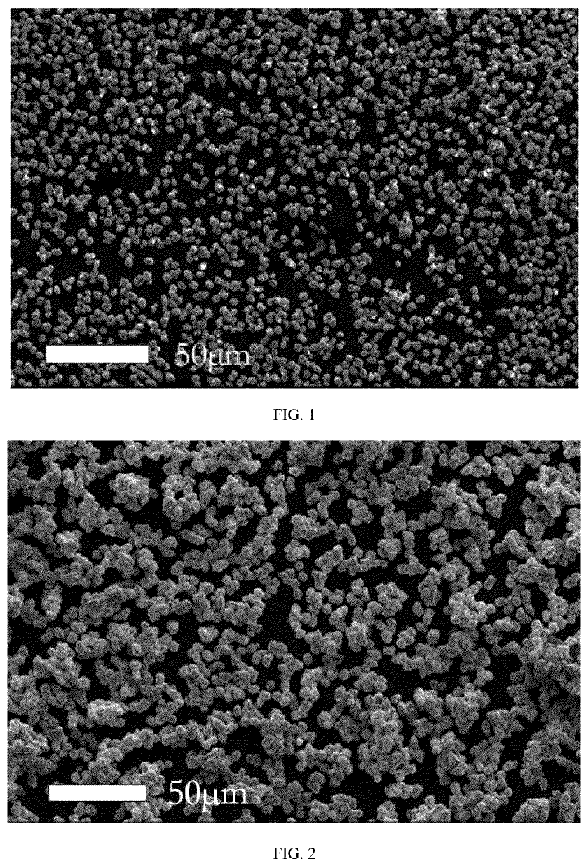

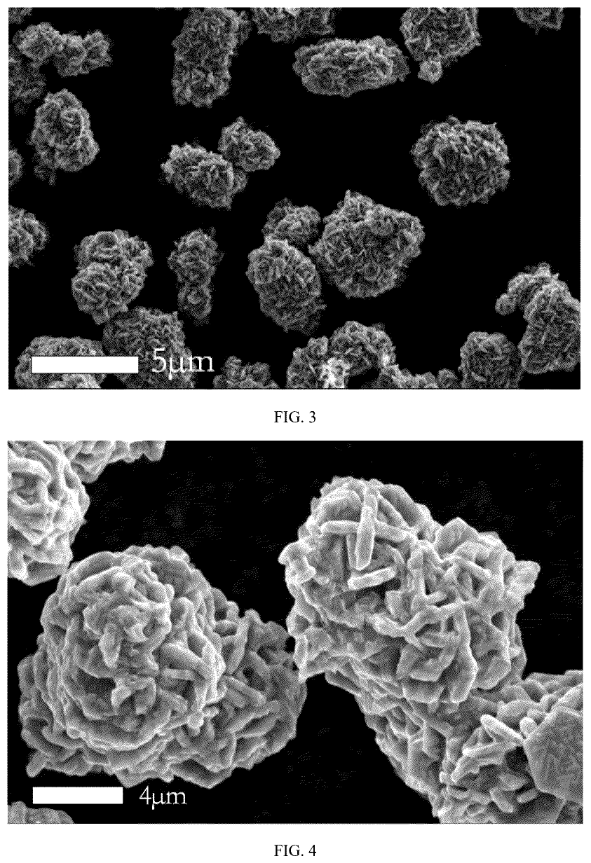

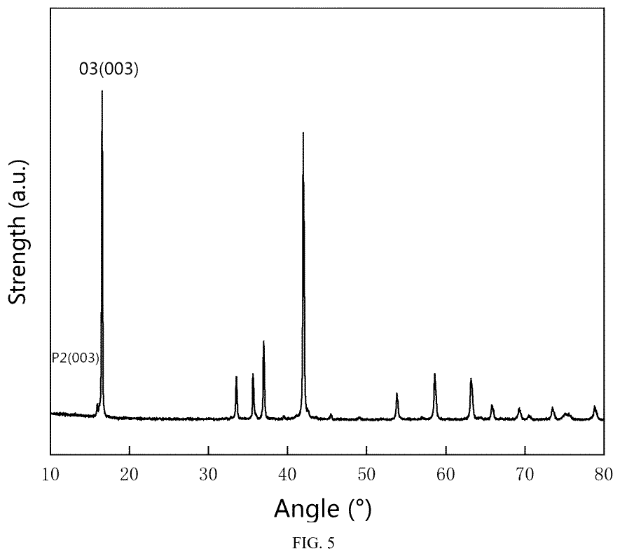

FIG. 1 is the SEM view of the prepared precursor, FIG. 3 is the partially enlarged SEM view of the prepared precursor, it can be seen from the figure that the precursor particles were successfully prepared, and the prepared precursor had good particle morphology and distribution. FIG. 2 is the SEM view of the prepared cathode material, FIG. 4 is the partially enlarged SEM view of the prepared cathode material, FIG. 5 is the XRD pattern of the prepared cathode material, it can be seen from FIG. 2, FIG. 4 and FIG. 5 that the cathode material was successfully prepared, and the prepared precursor particles and the cathode material had a two-phase structure.

### Embodiment 3

This embodiment prepares the composite sodium ion battery cathode material with radial heterojunction, including the following steps:

(1) nickel sulfate hexahydrate and manganese sulfate monohydrate were dissolved in deionized water according to the required ratio to obtain two mixed solutions. Where the Ni:Mn in the first mixed solution was 1:1, the Ni:Mn in the second mixed solution was 3:7, and the solution concentration was 2 M.

(2) Firstly, the first mixed solution, 4 M NaOH solution and 2 M NH₃·H₂O solution were simultaneously introduced into the reactor with nitrogen as the protective gas, the pH in the reactor was maintained at 11.2, and the ammonia concentration was maintained at 7.5 g/L, when the particle size of the material in the reactor reached 3.6 μm, 200 g of the material was taken out.

Then the first mixed solution was switched to the second mixed solution, the pH in the reactor was maintained at 11.2, and the ammonia concentration was maintained at 7.5 g/L, when the particle size of the material in the reactor reached 4.2 μm, 200 g of material was taken out each time; the precursor particles were screened out after washing and drying, where the core of the precursor particles was Ni_{0.5}Mn_{0.5}(OH)₂, and Ni_{0.3}Mn_{0.7}(OH)₂ with a size of 0.6 μm was deposited on the surface of the core.

(3) Na₂CO₃ and precursor particles were mixed uniformly according to the molar ratio of 0.9:1 (Na:M) to obtain the mixed material, the mixed material was first sintered at 500° C. for 6 h in the air atmosphere, and then transferred to the oxygen atmosphere furnace and sintered at 900° C. for 24 h. The cathode material sample can be obtained and denoted as NM+0.6 μm.

(4) The specific capacity of the first cycle discharge and the capacity retention rate after 300 cycles of the composite sodium ion battery cathode material were measured.

### Comparative Embodiment 1

The preparation for the sodium ion battery cathode materials includes the following steps:

(1) nickel sulfate hexahydrate and manganese sulfate monohydrate were dissolved in deionized water according to the required ratio to obtain two mixed solutions. Where the Ni:Mn in the first mixed solution was 1:1, the Ni:Mn in the second mixed solution was 3:7, and the solution concentration was 2 M.

(2) Firstly, the first mixed solution, 4 M NaOH solution and 2 M NH₃·H₂O solution were simultaneously introduced into the reactor with nitrogen as the protective gas, the pH in the reactor was maintained at 11.2, and the ammonia concentration was maintained at 7.5 g/L, when the particle size of the material in the reactor reached 3.6 μm, 200 g of the material was taken out; then the first mixed solution was switched to the second mixed solution, the pH in the reactor was maintained at 11.2, and the ammonia concentration was maintained at 7.5 g/L; the cathode material Ni_{0.5}Mn_{0.5}(OH)₂ were screened out after washing and drying, and denoted as NM.

(3) The specific capacity of the first cycle discharge and the capacity retention rate after 300 cycles of the composite sodium ion battery cathode material were measured.

The composite sodium ion battery cathode material with radial heterojunction obtained in embodiments 1-3 and the NM material obtained in the comparative embodiment 1 are used as the positive electrode, and the lithium metal sheet is used as the negative electrode, they are assembled into button batteries for charge and discharge comparison tests, the test results are as follows:

TABLE 1
Discharge specific capacity test data of battery cathode material

| | Specific capacity of | Capacity retention |
|---|---|---|
| | first cycle discharge | rate after 300 |
| | at 1 C rate (mAh/g) | cycles (%) |
| Embodiment 1 | 119.61 | 40.61 |
| Embodiment 2 | 109.85 | 64.61 |
| Embodiment 3 | 103.32 | 51.46 |
| Comparative embodiment 1 | 134.82 | 11.69 |

From Table 1, it can be concluded that the button battery is assembled for charge and discharge comparison test based on the composite sodium ion battery cathode material with radial heterojunction obtained in embodiments 1-3 is the positive electrode, and the lithium metal sheet is the negative electrode, the specific capacity of the first cycle discharge is up to 119.61 mAh/g at 1C rate, and the capacity retention rate is up to 64.61 after 300 cycles, although the specific capacity of the first cycle discharge of the NM material obtained by the comparative embodiment 1 as the positive electrode reaches 134.82 mAh/g, the capacity retention rate after 300 cycles is only 11.69%.

It can be seen that the cycle stability of the battery made of the composite sodium ion battery cathode material with radial heterojunction is much higher than that of the battery made of the cathode material of the ordinary sodium ion battery, and from a comprehensive point of view, the battery made of the composite sodium ion battery cathode material with radial heterojunction is superior to the battery made of the cathode material of the ordinary sodium ion battery, and the optimum thickness of the coating material of the composite sodium ion battery cathode material with radial heterojunction is 0.4 μm.

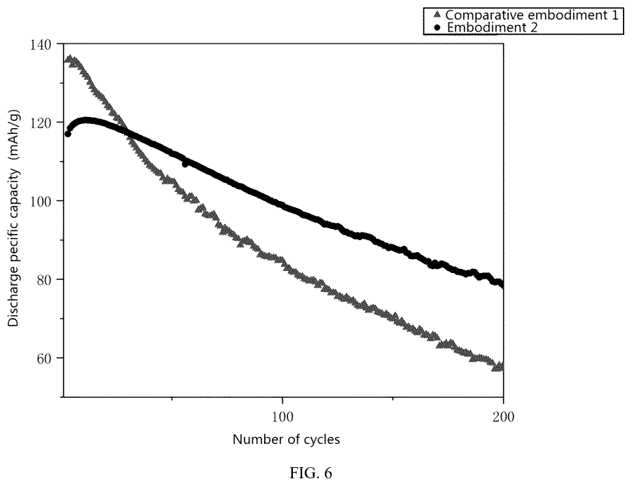

FIG. 6 is the diagram of the cycle performance comparison at 2.0-4.0 V between embodiment 2 and comparative embodiment 1, it can be seen from the figure that embodiment 2 performs well under long-cycle conditions and can maintain higher specific energy.

Therefore, the present invention adopts the above composite sodium ion battery cathode material with radial heterojunction and the preparation method thereof, while reducing the cost of the materials, the composite cathode materials with radially heterogeneous distributions are synthesized by constructing different thicknesses of Ni_{0.3}Mn_{0.7}(OH)₂ on the surface of Ni_{0.5}Mn_{0.5}(OH)₂ precursor, so as to improve the air stability and cycling stability of the materials, and improve the sodium ion transmission kinetic property, the present invention is low-cost, simple and reasonable, with good electrical properties, and is suitable for commercialized production.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A preparation method for a composite sodium ion battery cathode material with a radial heterojunction, wherein the composite sodium ion battery cathode material with the radial heterojunction is prepared by sintering a precursor and a sodium source, the composite sodium ion battery cathode material with the radial heterojunction is a core-shell structure with the radial heterojunction, a core of the composite sodium ion battery cathode material with the radial heterojunction is an O3-type nickel-manganese-based layered oxide, a coating material is on a surface of the core of the composite sodium ion battery cathode material with the radial heterojunction, and the coating material is a P2-type nickel-manganese-based layered oxide, and a thickness of the coating material is less than 1 μm;
the precursor has the core-shell structure, a chemical formula of a core of the precursor is Ni_{0.5}Mn_{0.5}(OH)₂, and Ni_{0.3}Mn_{0.7}(OH)₂ is deposited on a surface of the core of the precursor;
wherein the preparation method for the composite sodium ion battery cathode material with the radial heterojunction comprises the following steps:
step 1, dissolving a nickel salt and a manganese salt in deionized water according to a proportion to obtain a first mixed solution and a second mixed solution respectively, preparing a precipitant solution by adding a precipitant into the deionized water to dissolve, and preparing a complexing agent solution by diluting a complexing agent to a predetermined concentration;
step 2, simultaneously introducing the first mixed solution as a salt solution, the precipitant solution, and the complexing agent solution into a reaction kettle protected by a protective gas, maintaining a pH and a temperature in the reaction kettle, taking out a precursor material when a particle size of the precursor material reaches a requirement to obtain an extracted material, then switching the salt solution in the reaction kettle from the first mixed solution to the second mixed solution, and repeating operations of introducing, maintaining, taking out, and switching, wherein an ammonia concentration in the reaction kettle is maintained at 7.5 g/L;
step 3, obtaining a precursor particle of Ni_{0.3}Mn_{0.7}(OH)₂ coated Ni_{0.5}Mn_{0.5}(OH)₂ of a corresponding size by washing and drying the extracted material, wherein a size of the Ni_{0.3}Mn_{0.7}(OH)₂ is x μm, wherein 0≤x≤1;
step 4, obtaining a mixed material by uniformly mixing the sodium source and the precursor particle according to a predetermined molar ratio, and uniformly mixing the sodium source and the precursor particle according to the predetermined molar ratio of Na:M=0.9:1; and
step 5, firstly sintering the mixed material in an air atmosphere, secondly transferring the mixed material to an atmosphere furnace for a continued sintering, and finally synthesizing a series of cathode material NaₓNi_{y}Mn₂O₂ samples.

2. The preparation method for the composite sodium ion battery cathode material with the radial heterojunction according to claim 1, wherein a particle size of the precursor material is 3.6-4.2 μm.

3. The preparation method for the composite sodium ion battery cathode material with the radial heterojunction according to claim 1, wherein in the step 1, the nickel salt is one or more of nickel sulfate, nickel nitrate, and nickel chloride, the manganese salt is one or more of manganese sulfate, manganese nitrate, and manganese chloride, the precipitant is one or more of sodium hydroxide, sodium carbonate, sodium bicarbonate, potassium hydroxide, potassium carbonate, and potassium bicarbonate, and the complexing agent is one or more of ammonia and oxalic acid.

4. The preparation method for the composite sodium ion battery cathode material with the radial heterojunction according to claim 1, wherein a concentration of OH⁻/CO₃²⁻/HCO³⁻ in the precipitant solution is 3-7 mol/L and a concentration of the complexing agent solution is 1.5-2 mol/L.

5. The preparation method for the composite sodium ion battery cathode material with the radial heterojunction according to claim 1, wherein a ratio of Ni and Mn in the first mixed solution is 1:1, a ratio of Ni and Mn in the second mixed solution is 3:7, and a concentration of the first mixed solution and a concentration of the second mixed solution are 3-10 mol/L.

6. The preparation method for the composite sodium ion battery cathode material with the radial heterojunction according to claim 1, wherein a capacity of the reaction kettle is 50 L, the protective gas is nitrogen or argon, and the pH in the reaction kettle is 11.0-11.6.

7. The preparation method for the composite sodium ion battery cathode material with the radial heterojunction according to claim 1, wherein in the step 4, the sodium source is one or more of Na₂CO₃, NaOH, and NaNO₃.

8. The preparation method for the composite sodium ion battery cathode material with the radial heterojunction according to claim 1, wherein in the step 5, the mixed material is sintered at 500° C. for 6 h in the air atmosphere, and the mixed material is transferred to an oxygen atmosphere furnace and sintering at 900° C. for 24 h.
